(19) United States
(12) Patent Application Publication
(10) Pub. No.: US 2006/0141931 A1
(43) Pub. Date: Jun. 29, 2006

(54) Method for exchanging data between field devices

(75) Inventor: Eugenio Ferreira Da Silva Neto, Biel-Benken (CH)

Correspondence Address: BACON & THOMAS, PLLC, 625 SLATERS LANE, FOURTH FLOOR, ALEXANDRIA, VA, 22314, US

(73) Assignee: Endress + Hauser Process Solutions AG, Reinach (CH)

(21) Appl. No.: 10/528,143

(22) PCT Filed: Sep. 9, 2003
(86) PCT No.: PCT/EP03/10010

§ 371 Date: Nov. 7, 2005

(30) Foreign Application Priority Data
Sep. 19, 2002 (DE) 102 43 619.3

(51) Int. Cl. H04B 5/00

(52) U.S. Cl. 455/41.1

(57) ABSTRACT

A method for exchanging data between field devices used in automation technology. The method permits data exchange via radio waves in addition to a data exchange via a field bus. This permits a more rapid data exchange, which is not restricted by the protocol control of the field bus.

The invention relates to a method for data exchange between field devices, as defined in the preamble of claim 1.

Frequently applied in process automation technology are field devices, which serve for registering and/or influencing process variables. Examples of such field devices are fill level measuring devices, mass flowmeters, pressure meters, temperature meters, etc., which, as sensors, register the corresponding process variables fill level, flow rate, pressure, and temperature, respectively.

Serving for influencing process variables are the so-called actuators, which, e.g. as valves, influence flow rate of a liquid in a section of pipeline.

The field devices are, as a rule, connected with a central control unit, which controls and/or monitors total process flow. In the central control unit, the measured values of the various sensors are evaluated and the appropriate actuators activated for influencing the process.

Data transmission between the field devices and the control unit occurs according to known international standards for fieldbusses, such as e.g. HART®, Foundation Fieldbus®, Profibus®, CAN-Bus®, etc. Besides process control, also configuring and parametering of the field devices is done from a control unit.

U.S. Pat. No. 5,793,963 discloses a method for data exchange between a control unit and a field device. The method includes transmission of data both via the fieldbus and via radio waves.

Recently, also a direct data exchange between field devices has become possible over the data bus. This data exchange between field devices via the data bus is, however, relatively slow and is limited considerably by protocol rules.

An object of the present invention is to provide a method for data exchange between field devices lacking the aforementioned disadvantages while being especially simple and cost-favorable to put into practice and enabling a fast data exchange.

This object is achieved by the method defined in claim 1.

An essential idea of the method is to provide, besides the data exchange via the data bus, a radio connection between the field devices.

Via this radio connection, a fast data exchange can occur between the field devices.

Advantageous further developments of the invention are presented in the dependent claims.

A simple embodiment of the radio connection is based on the Bluetooth standard. In this way, standard components can simply be placed in the field devices.

In a further development, the field devices exchange data on process conditions and an evaluation of the state of the process occurs. In a further development, configuration and parametering data are exchanged between the field devices. In this way, the properties of two field devices can easily be made the same.

The invention will now be explained in greater detail on the basis of an embodiment illustrated in the drawing, the figures of which show as follows:

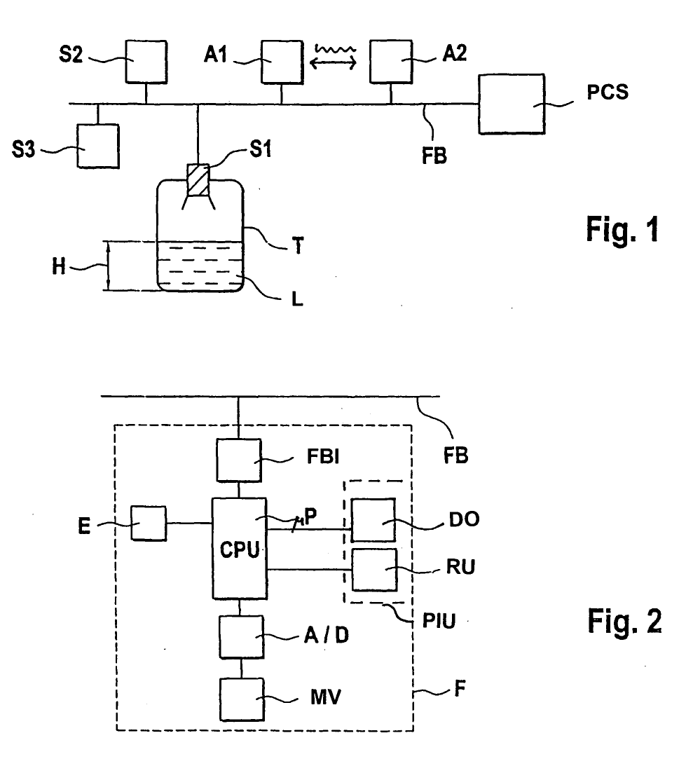

FIG. 1 a schematic drawing of a fieldbus with multiple field devices; and

FIG. 2 a schematic drawing of a field device designed for the method of the invention.

In FIG. 1, by way of an example of a field device, a fill level measuring device S1 is shown in greater detail arranged on a tank T. The fill level measuring device S1 measures the fill height H in the tank T by means of a radar travel-time method. In such case, a radar pulse is sent from the fill level measuring device S1 in the direction of the surface of the liquid L and the radar pulse reflected from the surface is registered. Using the travel time of the radar pulses, the height H of the liquid is determined.

The fill level measuring device S1 is connected via a fieldbus FB with a process control system PCS, which serves as central control unit. The fill level measuring device S1 and the process control system PCS can communicate with one another via the fieldbus FB using known standards. As a rule, the current measured values of the fill level measuring device S1 are transmitted to the process control system and evaluated there and the appropriate actuators activated.

Connected to the fieldbus are, by way of example, additional sensors S2, S3 and actuators A1, A2. With the help of these sensors S2, S3, other process variables are measured, and, with the help of the actuators A1, A2, influenced. Each of the two actuators A1 and A2 has its own radio unit, so that actuators A1 and A2 can also exchange data by radio wave transmission.

FIG. 2 is a schematic illustration of a field device F. The field device includes a microprocessor μP and a memory E. The microprocessor μP is connected via an analog/digital converter A/D with a measured-value pickup MV. The measured-value pickup MV serves for measuring a process variable, e.g. the fill level H.

The field devices S1, S2, S3, A1, A2 exchange data both with the control system PCS and with one another.

Via a fieldbus interface FBI, the microprocessor up is connected with the fieldbus FB. Additionally, the microprocessor μP is connected with a radio unit RU and a display/operating unit DO. In advantageous manner, the display/operating unit DO and the radio unit RU are provided as a plug-in unit PIU indicated by the dashed box.

The method of the invention will now be explained in greater detail.

If two field devices each have a radio unit RU, then these field devices can exchange data not only over the fieldbus FB, but also via radio wave transmission. An essential advantage of data transmission by radio is that data transmission can occur significantly faster between the field devices than is the case via the fieldbus, which, as a rule, enables only a relatively slow data exchange.

A further advantage is that data transmission by radio is not limited by the rules of protocol of the data bus being used.

Advantageously, the radio unit works according to the Bluetooth standard. Bluetooth components are available on the market at favorable cost and are suited for short-range radio connection in near distances of up to 5 m.

If a malfunctioning field device has to be replaced, the configuring and parametering of the replacement device can be omitted in simple manner by exchanging the configuring and parametering data between the two field devices by radio wave transmission.

Following the data transmission, there are then two field devices present having identical properties. This can be referred to as the “cloning” of field devices.

Furthermore, the field devices can exchange process conditions, process data, diagnosis data, etc. via the radio connection and evaluate these in a field device having greater storage capabilities. In this way, a safe determining of the state of the process is possible independently of the data transmission over the fieldbus FB.

Running in the field devices are special software programs, which are also referred to as firmware. Sometimes for this, it is necessary to adapt the firmware in the field devices by software updates.

Software updates can, in simple manner, be sent via the data bus to a special field device. This field device then transmits the updates to other field devices by radio wave transmission. In this way, the loading of the data bus FB is significantly lessened.

Also the operating of a field device can be done from another field device via the radio connection between the two field devices.

1-6. (canceled)

7. A method for data exchange between field devices of automation technology, comprising the steps of: providing the field devices with a fieldbus interface for connecting with a fieldbus; providing a radio unit; and
exchanging data between the field devices and the radio unit utilizing radio wave transmission.

8. The method as claimed in claim 7, wherein:
the radio unit works according to the Bluetooth standard.

9. The method as claimed in claim 7, wherein:
the field devices exchange data concerning process conditions and an evaluation of the state of the process occurs.

10. The method as claimed in claim 7, wherein:
the field devices exchange configuring and parametering data.

11. The method as claimed in claim 7, wherein:
the field devices exchange software updates.

12. A field device for use providing the field devices with a fieldbus interface for connecting with a fieldbus; providing a radio unit; and exchanging data between the field devices and the radio unit utilizing radio wave transmission, wherein: the radio unit and a display/operating unit form an exchangeable unit.
